(19) United States
(12) Patent Application Publication
(10) Pub. No.: US 2009/0186314 A1
(43) Pub. Date: Jul. 23, 2009

(54) DENTAL DISTRACTOR

(75) Inventors: Richard Pober, Waban, MA (US); Elif Idil Kesser, Boston, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: Richard Pober, Waban, MA (US)

(21) Appl. No.: 12/353,741

(22) Filed: Jan. 14, 2009

Related U.S. Application Data
(60) Provisional application No. 61/011,217, filed on Jan. 17, 2008.

(51) Int. Cl. A61C 7/00

(52) U.S. Cl. 433/18; 433/24

(57) ABSTRACT

This invention comprises an orthodontic dental distractor for rapid orthodontic tooth movement, particularly into a fresh extraction socket. The rapid movement can occur from the effect of distraction osteogenesis.

The device can include four components: a molar tooth band with buccal tube, a canine tooth band with buccal tube, a threaded screw, and a screw retaining clip. The threaded screw is engaged internally to the molar band tube which is threaded internally. The screw head bears externally on the anterior (mesial) end of the clip, and the clip bears externally on the canine band tube so that when the screw is turned the canine tooth moves distally toward the molar tooth. Thus the movement of a tooth can be controlled to proceed at a rapid and prescribed rate.

### BACKGROUND OF THE INVENTION

Correction of front teeth crowding and protrusion is a condition which usually requires orthodontic treatment. There may also be other reasons for using orthodontic treatments to correct problems by changing the relative positions of teeth by orthodontic tooth movement.

Conventional orthodontic treatment for severe anterior teeth crowding or protrusion generally requires one and a half to two years. Usually, there are five major steps of the treatment procedure, as follows: extracting the first premolars; initial teeth leveling using orthodontic brackets and arch wires. Depending on the alignment of teeth, this step lasts about three to six months; retracting canine teeth to posterior positions, into extraction sockets (spaces), for gaining space to retract the incisors or resolve crowding. This step lasts about four to six months for children and seven to eight months for adults; retracting anterior teeth to level protruding teeth. This step lasts about six months; and final adjustment of occlusion and tooth angulation. This step lasts about three to six months.

Most patients consider this treatment procedure to be of excessive duration. Also, it is neither esthetic nor comfortable to wear braces for such a long period and it is very difficult for patients to maintain good oral hygiene as well. Also, it is very inconvenient and time consuming for patients to continually visit an orthodontist's office over such a long period. Two steps of this treatment account for the majority of time of treatment; they are canine retraction and anterior retraction, which require about a year to complete. Several techniques have been tried to shorten the time needed for these two steps; however, there has not been significant reduction of total treatment duration, except for the use of a distractor combined with surgical tooth socket modification.

A proposed procedure for performing rapid orthodontic tooth movement has included the steps of applying orthodontic brackets for initial alignment and leveling anterior teeth for about one month followed by extraction of first premolars and applying distractors to move the canine teeth to new positions within about three weeks. This is followed by retraction of the anterior teeth rearward (distally) for about six months and final adjustment of occlusion and tooth angulation.

Although prior devices may produce rapid orthodontic movement, they have the deficiencies of being complicated and large, requiring detailed custom manufacturing for each patient. Prior systems have been designed to address concerns over the possibility of excessive tilting of the canine tooth during rapid canine distalization, as well as anchorage loss, damage to pupal tissue and/or nerve damage. Prior designs mounted screws on retention arms generally more than 5 mm away from the tooth bands in the buccal vestibule to minimize tipping, but this design increased the likelihood of mucosal irritation. Consequently, the large size results in irritation within the oral cavity, which is very uncomfortable, if not painful, for the patient, so that these devices have failed to be adopted for commercial use.

Thus, while prior devices are suitable to induce rapid tooth movement via distraction osteogenesis for certain patients, they have failed to achieve widespread use, and consequently further improvements are needed.

### SUMMARY OF THE INVENTION

The present invention relates to a dental distractor for orthodontic treatment. A preferred embodiment is used to provide sufficient force for rapid tooth movement subsequent to tooth extraction and has a reduced size to provide less discomfort to the patient.

Any protrusion from a dental arch presents the opportunity for irritation within the oral cavity. Consequently, a primary requirement for a safe and effective distractor is small size. A simple design with minimal components allows an orthodontist to install the device with minimal labor and minimal discomfort for a patient. A simple design with minimal components allows for minimal cost for manufacturing as well as ease of use. The system has a low profile that extends less than 5 mm from the buccal surface of each tooth on which the system is mounted such that the patient experiences minimal discomfort or irritation associated with use. The tubular structure is attached directly to the tooth band and generally extends 4 mm or less from the surface of the tooth and preferably less. For example, traditional orthodontic treatments with bands, brackets and archwire typically fall within 3 mm of the surface of each tooth and have smoothed surfaces and edges to minimize the risk of abrasion of the mucosa within the mouth of the patient. Preferred embodiments of the present invention are configured to fall within the same working volume of traditional orthodontic appliances and will thus be acceptable to the majority of patients suitable for this course of treatment. Moreover, it was found that this design did not increase the likelihood of excessive tilting of teeth during rapid canine distalization, nor did the design result in an increased risk of anchorage loss or other tissue damage.

Preferred embodiments of the invention utilize a system and method for the quick installation of the mechanical coupling, such as a screw or rod, that is used to apply the force needed for rapid tooth movement. This provides a more rigid structure without the need for additional sliding bars that have been used previously to provide a more rigid but bulky system for rapid distraction.

The object of the present invention is a dental distractor that moves a tooth rapidly into a fresh extraction socket in a short period of time, so that the time needed for orthodontic treatment is significantly reduced. The use of this invention is based on the process of distraction osteogenesis that can induce new bone formation at a rate of about 0.5-1 millimeter per day. The device can be actuated periodically by the user to obtain about 0.3 mm of tooth movement, for example, every time the user adjusts the device to maintain the requisite applied mechanical force.

This invention alleviates the problem of long time duration orthodontic treatment resulting from the conventional method of using an elastic power chain or springs, which apply less force with time as the teeth move, and require replacement.

A preferred embodiment of this invention uses a single screw, rod or member coupled at a distal portion to a first tooth and at a proximal portion to a second tooth. The distal section can be attached to a molar band with a buccal tube. A canine band can be attached to the proximal section with a buccal tube and a screw retaining clip. The buccal tube of the molar band is internally threaded to permit engagement of the externally threaded screw or rod. The buccal tube of the canine band, and the retaining clip, have smooth bores with clearance to allow the externally threaded screw to rotate and slide freely within and through the tube and clip. The tubes can be mounted on the side surface (e.g. the buccal surface) of each band and extend 3 mm or less from the side surface, and preferably 2.5 mm or less, to provide a low profile configuration. This also provides a more rigid structure than those previously in use, as the tubes are mounted directly onto the tooth bands without any interviewing support arms. In another embodiment, the more proximal tube can be attached to a band that extends around one side of the canine tooth, such that a force is applied to both buccal and lingual sides of the canine tooth. This embodiment provides a balanced force for tooth movement.

Turning the externally threaded screw moves the retaining clip against the canine band tube in a prescribed motion determined by the pitch of the thread. As the screw head pushes the clip against the canine buccal tube, for example, a force is applied which moves the canine tooth distally toward the molar tooth. As the screw is rotated, the canine tooth is moved toward the molar tooth. In certain embodiments, the screw progressively protrudes from the posterior end of the molar buccal tube. Using a tool such as a screw or nut driver, a patient can adjust the distractor according to a schedule prescribed by an orthodontist, and thus effect rapid tooth movement without continually returning to an orthodontist. For example, a #0-80 screw thread produces a movement of about 0.3 millimeters per revolution; thus one turn at morning time and one turn at night time can result in about 0.6 millimeters movement per day of a canine tooth, for example. This procedure results in a significantly shorter duration of orthodontic treatment and fewer visits to an orthodontist, which is beneficial for the patient.

Another embodiment of this invention comprises a molar band with attached buccal tube, a canine band with attached buccal tube, a screw retaining clip, an externally screw threaded rod, and an internally screw threaded nut. The buccal tube of the molar band is internally screw threaded to permit engagement of the externally screw threaded rod. The buccal tube of the molar band is internally screw threaded for only a portion of its length, so the externally screw threaded rod becomes fixedly engaged when it is screwed into the threaded portion of the tube. The screw retaining clip and the buccal tube of the canine band have smooth bores and clearance to allow the externally screw threaded rod to rotate and slide freely within and through the tube and clip.

Turning the internally screw threaded nut on the externally screw threaded rod moves the nut in a prescribed motion determined by the pitch of the thread. As the nut pushes against the screw retaining clip, which pushes against the canine buccal tube, a force is applied which moves the canine tooth toward the molar tooth. As the nut is rotated, the canine tooth is moved distally toward the molar tooth, and the threaded rod progressively protrudes from the anterior end of the canine buccal tube. Using a tool such as a nut driver, a patient can adjust the distractor according to a schedule prescribed by an orthodontist, and thus maintain rapid tooth movement without continually returning to an orthodontist.

Details relating to the novelty of this invention are disclosed in the description of drawings and the detailed description of the preferred embodiment.

### DESCRIPTION OF THE DRAWINGS

The following drawings and descriptions depict the invention, and indicate its novel features and benefits compared to prior inventions of this type.

FIG. 1A is a perspective view of a preferred embodiment of the invention.

FIG. 1B shows the relative positions of the components of the invention upon attachment to molar and canine teeth; this embodiment of the invention is comprised of molar band 100 with attached buccal tube 102, canine band 200 with attached buccal tube 202, retaining clip 300, and screw 400.

FIGS. 2A-2D show details of molar band 240 with attached buccal tube 244.

FIGS. 3A-3D show details of canine band 262 with attached buccal tube 264.

FIGS. 4A-4E show details of retaining clip 286.

FIG. 5 shows another embodiment of this invention. This embodiment is comprised of molar tooth band 500 with attached buccal tube 502, canine tooth band 200 with attached buccal tube 202, screw retaining clip 300, threaded rod 600 engaged internally to molar buccal tube 502, and nut 602 engaged on the anterior end of threaded rod 600.

FIGS. 6A-6E show details of molar band 500 with attached buccal tube 502.

FIGS. 7A-7E illustrate a preferred embodiment in which a first tube slides within a second tube.

FIG. 8 illustrates a process sequence for manufacturing a preferred embodiment of the invention.

FIG. 9 illustrates a preferred embodiment of the invention using coupling band to apply a force across the anterior surface of the canine tooth.

FIG. 10 illustrates a side view of the embodiment of FIG. 9.

### DETAILED DESCRIPTION OF THE INVENTION

This application claims priority to U.S. application Ser. No. 61/011,217 filed on Jan. 14, 2008, by Richard Pober, the entire contents of which is incorporated herein by reference.

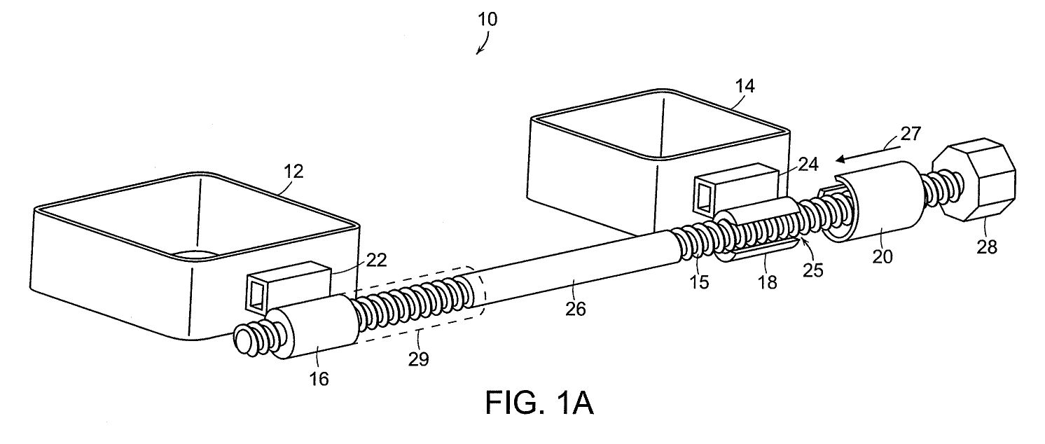

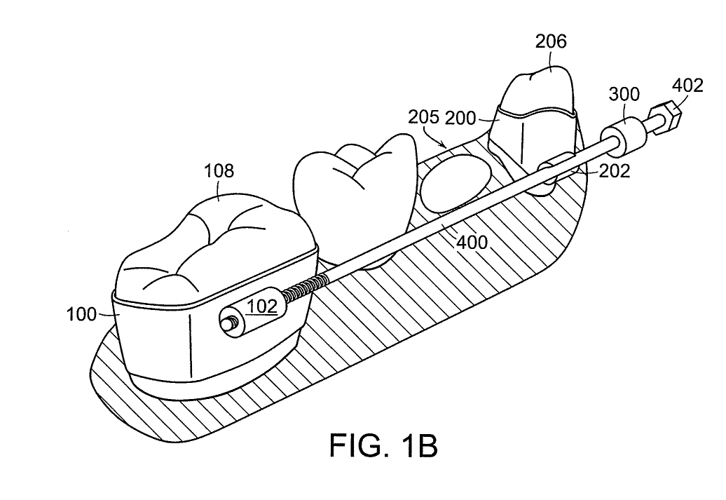

A preferred embodiment of a device 10 in accordance with the invention is shown generally in FIG. 1A. This device has tooth bands 12, 14, tubes 16, 18 that retain the coupling element 26 to the bands 12, 14, and second (or more) tubes 22, 24 that can optionally also be attached to the bands 12, 14 and/or tubes 16, 18. The tube body 16 and second tube 22 can be formed as a unitary metal tube body that can be attached to band 12 as described further herein. Note that tube body 16 can optionally extend 29 to enclose the distal threading. The threading 15 can extend the entire length of the tube 16 or in another embodiment the proximal threading 15 is not necessary. This can increase the diameter of rod 26 and thus increase rigidity. Similarly, tube body 18 can be formed with tube 24 to form a unitary tube body. Tube 18 can have an opening or slot 25 through which the coupling element can be inserted for ease of assembly. A preferred embodiment of the invention uses a single coupling element, such as a rod, bar or threaded screw. A retaining element 20 can be moved laterally 27 during assembly to engage the tube 18 to prevent the element 26 from exiting the tube 18 through opening or slot 25. A screw head or nut 28 can be actuated or turned to impart a lateral force to the tooth band 14 relative to band 12 through coupling 26.

FIG. 1B shows the relative positions of the components of the invention upon mounting within the mouth of a patient. A molar tooth 108 and a canine tooth 206 are shown subsequent to removal of a tooth 205. A molar band 100 has an attached buccal tube 102. A canine band 200 has an attached buccal tube 202. The molar and canine bands are shown in position as they are used for orthodontic treatment to eliminate space between teeth, particularly after extraction of a tooth.

This invention utilizes particular features and properties of buccal tubes 102 and 202 to provide for rapid tooth movement after extraction. Molar buccal tube 102 is screw threaded internally and counterbored, to accept threaded screw 400, which permits the device to be assembled easily and quickly within a patient's mouth. Canine buccal tube 202 is slotted axially to allow screw 400 to be easily inserted through slot 25 in a radial direction.

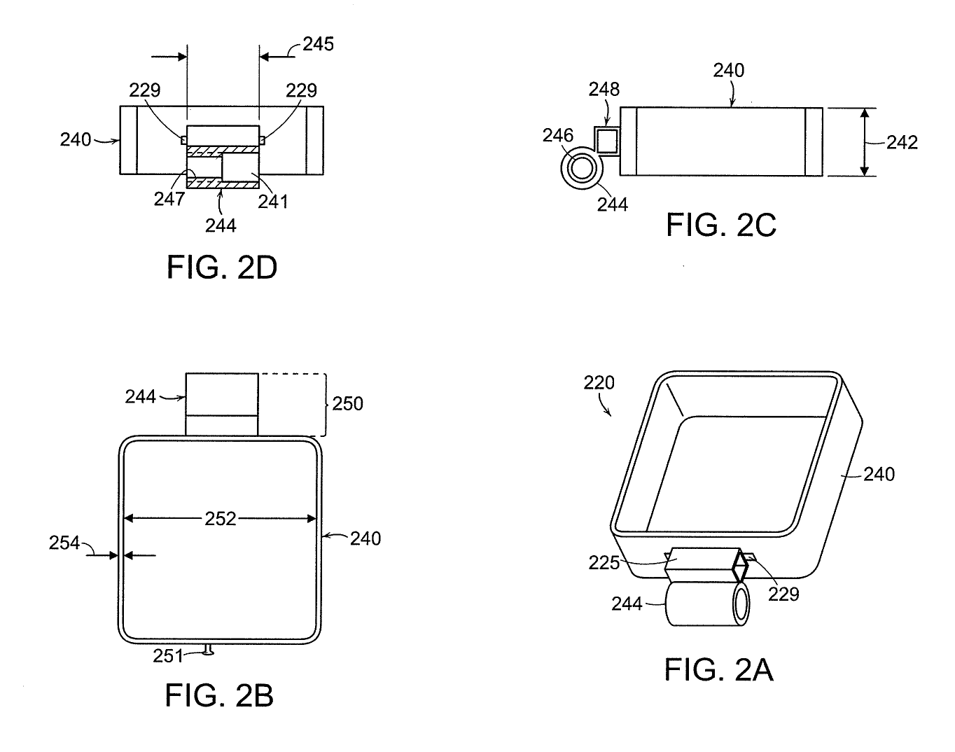

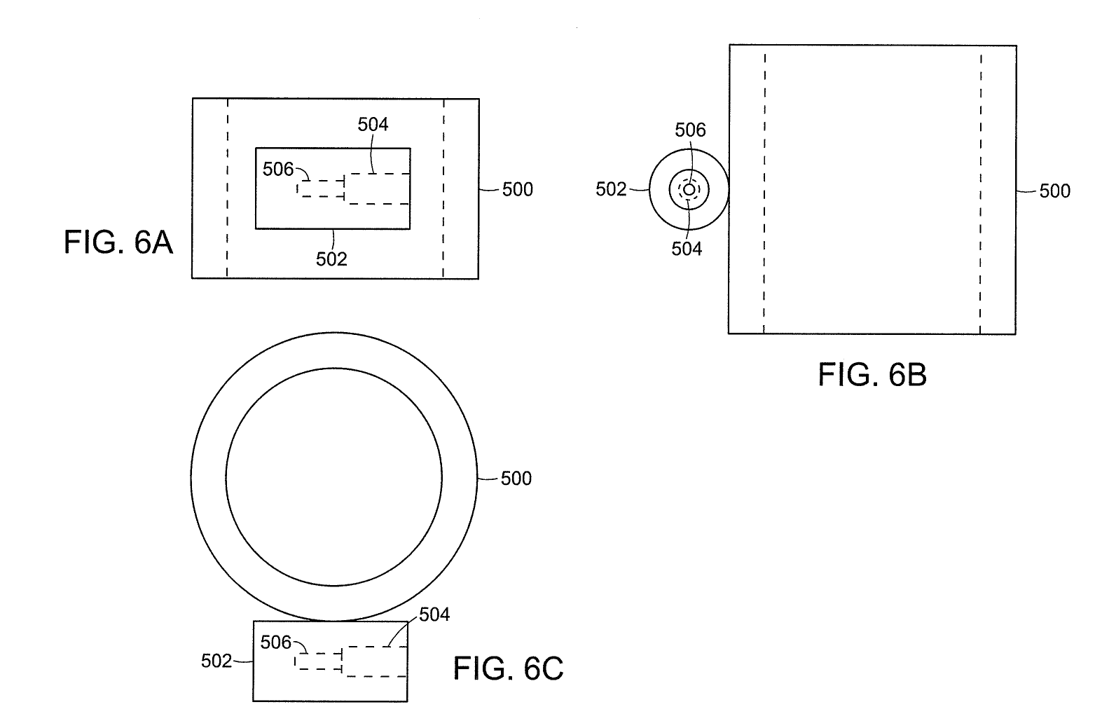

FIGS. 2A-2D show features of molar attachment 220 including buccal tube 244 on molar band 240. Counterbore 241 provides clearance for the outside diameter of screw at the anterior (mesial) end of buccal tube 244, to allow “automatic” alignment of the threaded end of screw when it is being engaged to the internally threaded portion 247 of molar buccal tube 244. Attachment elements or tabs 249 extend from the first and second ends of the tubes 244. These can be used to provide at least two welding point to attach the tube to the molar band because of the small size and pitch of the threaded components, it is difficult to engage them without cross-threading, unless the components are aligned coaxially. The curvature of a dental arch requires the threaded rod to curve as it conforms to the shape of the arch. Thus, it is difficult to coaxially align the internally threaded tube and externally threaded rod or screw when engaging them within the oral cavity. The embodiments of buccal tube 244, as described and shown in FIGS. 2A-2D, and buccal tube 502, as described and shown in FIGS. 6A-6E, ensure coaxial engagement of the threaded rod or screw within the threaded tube. This feature is highly desirable for the person placing the distractor into service, as molar band 100 is positioned at the rear of a patient's mouth where there is limited access for manipulation of a plurality of components. The canine and molar tubes have a length 272 in a range of 1 to 6 mm with the preferred lengths being in a range of 2 to 4 mm for this embodiment. The tube body 244 extends a distance 250 of 4 mm or less and preferably 3 mm or less from the surface of band 240, which has a thickness 254 and width 252, and a second 225, or more, tubes can be used. Tube 225 and tube 244 can be manufactured as a single unitary tube body structure using a powdered metallurgy molding process. This process can be used to form attachment elements or tabs 229 that are used to attach the tube 225 (or 102) to the molar band.

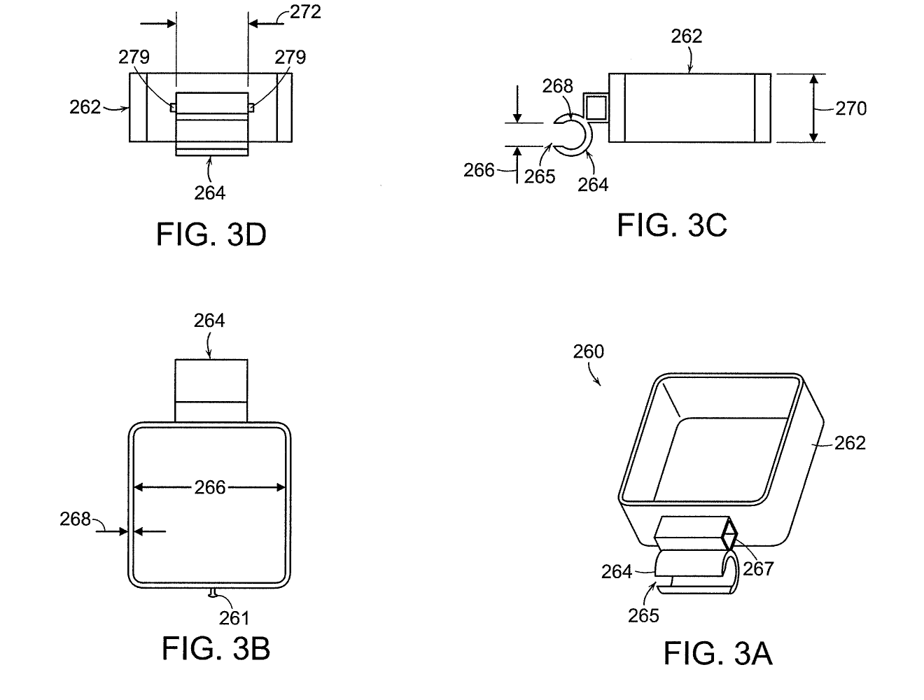

FIGS. 3A-3D show features of canine buccal tube 264. A feature is that the bore of canine buccal tube 202, 264 is a size which permits threaded screw to rotate and slide freely within and through tube 264. Tabs 279 can be used to attach the one or more tubes to the canine band. Another optional feature of canine buccal tube 264 is an axial slot 265 that extends along the length. The width 266 of slot 265 is such that a screw may be inserted in a radial direction, and thus become positioned within the tube without the necessity of passing the full length of screw through tube 264. Width of slot 265 may be slightly larger than diameter of screw or slightly smaller. If slightly smaller, screw can be pushed through, and slot 265 will expand as tube 264 flexes elastically and returns to its original size after screw is within tube 264. A useful and novel aspect of this feature is that screw may be easily screwed into internally threaded molar buccal tube 244 on molar band 240 without the necessity of canine tube 264 and molar tube 244 being coaxially aligned. After engaging the threaded end of screw into molar buccal tube 244, the screw may then be easily engaged to canine buccal tube 264. This feature is highly desirable for the person placing the distractor into service.

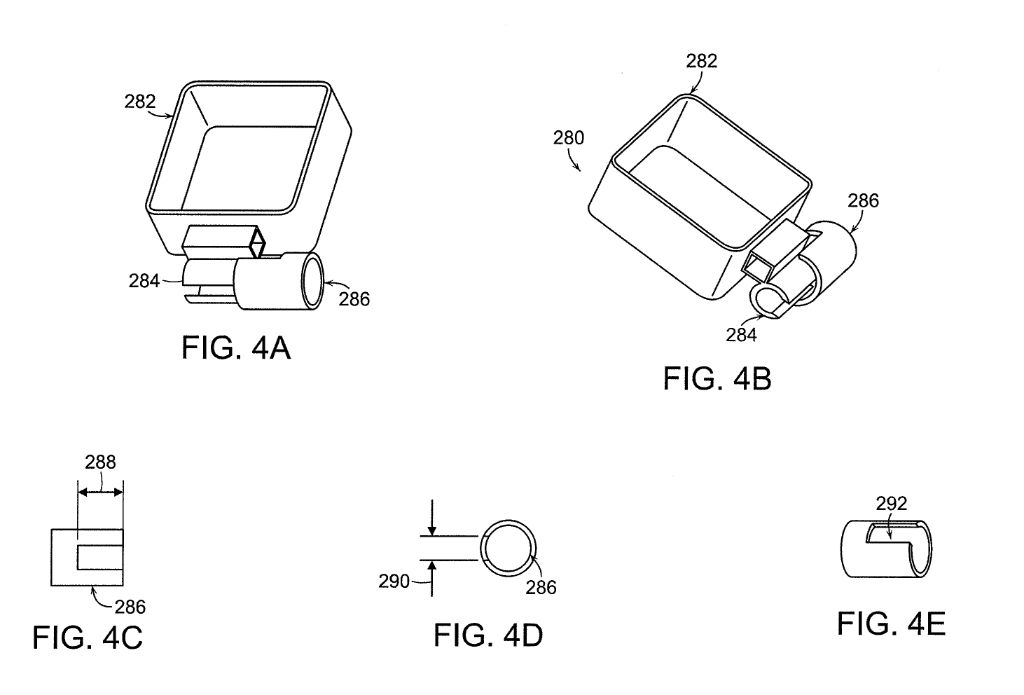

FIGS. 4A-4E show a canine (or molar) attachment 280 including screw retaining clip 286. Axial slot 292 extends partially along the length of clip 286. The width of slot 292 is sufficient to allow clip 286 to slide coaxially over the portion of canine buccal tube 284 that is attached to canine band 282. Two useful features of slot 292 extending only partially along the length of clip 286 are: first, to ensure that there is a complete circle of material to prevent clip 286 from becoming disengaged from screw during installation, and second, to push against canine buccal tube 284 when the screw head pushes against anterior (mesial) end of clip 286. The inside diameter or size of retaining clip 286 is large enough to provide clearance for the outside diameter or size of canine buccal tube 284. The width of slot 292 is smaller than the outside diameter of canine buccal tube 284 so clip 286 can not become detached from canine buccal tube 284. Thus, clip 286 is retained on screw, is easily engaged to canine buccal tube 284, and keeps screw engaged within canine buccal tube 284.

Screw head 402 is conveniently located within the oral cavity to permit a patient to turn it with a tool. As screw 400 rotates and advances into molar buccal tube 244, screw head 402 pushes against retaining clip 286 which pushes against canine buccal tube 284, causing canine buccal tube 284 to move in a prescribed motion determined by the pitch of the screw thread of screw 400.

Instructions from an orthodontist will dictate the number of turns and how many times per day to be used, to effect a prescribed rapid tooth movement. A tool, such as a nut driver, permits a patient to easily turn a hex head screw and thus produce the desired rapid tooth movement without the necessity of repeated visits to an orthodontist.

FIG. 1B shows the described invention as it is used to retract a tooth. In particular, this invention can be used to move a canine tooth rapidly toward a molar tooth after extraction of an intervening tooth.

The preferred embodiment of this invention is described for use on the buccal side of a dental arch. It will be appreciated by a person skilled in the art of this invention that the invention may also be used on the lingual side of a dental arch. Note that the lingual side of each band can have a hook or protrusion 251, 261 that an elastic or wire, etc. can be attached to aid in control of tooth movement.

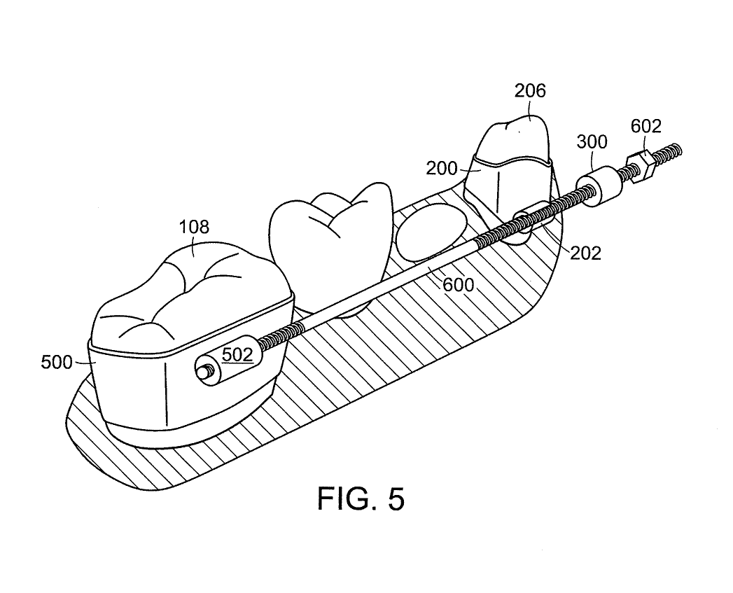

FIG. 5 shows the components which comprise another embodiment of this invention. Molar band 500 has an attached buccal tube 502. The canine band 200 is attached to buccal tube 202. The molar and canine bands are shown in position as they are used for orthodontic treatment to eliminate space between teeth, particularly after extraction of a tooth.

This invention utilizes features and properties of buccal tubes 502 and 202. The molar band buccal tube 502 is screw threaded internally and counterbored, to accept threaded rod 600, which permits the device to be assembled easily and quickly within a patient's mouth.

A feature of the described invention is that molar tube 502 is threaded only partially along its length, so threaded rod 600 can become fixedly engaged within the tube as it is turned. It will be appreciated by a person well versed in the art of this class of invention that if the length of threaded end of the screw threaded rod that engages tube 502 is shorter than the length of thread within the tube that the screw thread will also become fixedly engaged. Other devices that can easily attach the threaded rod 600, such as a bracket, are within the scope of the present invention.

Nut 602 is located conveniently within the oral cavity to permit a patient to turn it and thus adjust its position in a controlled manner along threaded rod 600. As the nut moves, it pushes against retaining clip 300 which pushes against buccal tube 202 on the anterior tooth, and moves it toward a posterior position. Instructions from an orthodontist will dictate the number of turns and how many times per day to be used, to effect a prescribed rapid tooth movement. A tool, such as a nut driver, allows a patient to easily turn the nut and thus produce the desired rapid tooth movement without the necessity of repeated visits to an orthodontist.

FIGS. 6A-6E show features of molar buccal tube 502. Counterbore 504 provides clearance for the outside diameter of threaded rod 600 at the anterior (mesial) end of buccal tube 502, to allow “automatic” alignment of the end of threaded rod 600 when it is being engaged to the internally threaded portion 506 of molar buccal tube 502. Because of the small size and pitch of the threaded components, it is difficult to engage them without cross-threading, unless the components are aligned coaxially. The curvature of a dental arch requires the threaded rod to curve as it conforms to the shape of the arch. Thus, it is difficult to coaxially align the internally threaded tube and externally threaded rod or screw when engaging them within the oral cavity. The designs of buccal tube 244, as shown in FIGS. 2A-2D, and buccal tube 502, as described and shown in FIGS. 6A-6E, ensure coaxial engagement of the threaded rod or screw within the threaded tube. This feature is highly desirable for the person placing the distractor into service, as molar band 500 is positioned at the rear of a patient's mouth where there is limited access for manipulation of components of this invention. Other methods of easily attaching threaded rod 600 to buccal tube 502 can also be used.

Another feature is that the bore of canine buccal tube 264 is a size and smoothness which permits threaded rod 600 to rotate and slide freely within and through the tube.

The described action causes distraction osteogenesis to be activated, which results in rapid movement of a tooth and reduction of space between two teeth. A primary use of this invention is for moving a canine tooth in a posterior direction after a first premolar has been extracted.

Another feature of this invention is that the diameter of threaded rod 600 and screw 400 are such that they are accommodated within the size of a conventional buccal tube, thus resulting in a device which is essentially the minimum size suitable for easy manufacturing relative to conventional orthodontic devices. A screw thread size which is accommodated by a conventional buccal tube is about 1.5 millimeters diameter, i.e. a #0-80 standard thread size. It was discovered that this size screw thread is rigid enough and strong enough to withstand the force necessary to actuate rapid tooth movement via distraction osteogenesis. A person well versed in the art will appreciate that other thread sizes, including metric sizes, may be used. Smaller size threads can be weaker and less stiff, whereas larger size threads are stronger and stiffer and accommodate the use of more applied force.

A feature of another embodiment of this invention is the use of a threaded rod or screw that is threaded at both ends and not threaded at a central portion, and each end thread is at least a minimal length suitable for the engagement of the tube or nut at the respective end. Thus, it is possible to increase the stiffness of the screw or threaded rod without increasing its diameter, i.e. by partial threading. The unthreaded length and position (location) can be determined by the length of movement required for a patient's tooth, and the configuration of the components of the distractor. A posterior end of a threaded rod can have a threaded length of about 8 to 10 millimeters to engage a threaded molar buccal tube, while an anterior end can have a threaded length of about 1 to 2 millimeters.

FIG. 5 shows the described invention as it is used to retract a tooth. In particular, this invention can be used to move a canine tooth rapidly toward a molar tooth after extraction of an intervening tooth.

This embodiment of this invention is described for use on the buccal side of a dental arch. It will be appreciated by a person skilled in the art of this invention that the invention may also be used on the lingual side of a dental arch.

When a patient is receiving rapid orthodontic treatment with a distractor, a canine tooth must be moved toward a posterior position immediately after the first premolar is extracted and before new alveolar bone is generated. Molar band 500 is affixed to a molar tooth and canine band 200 is affixed to a canine tooth; this can be done either before or immediately after the first premolar tooth is extracted.

Screw threaded rod 600 is inserted coaxially within molar buccal tube 502 and engaged thereto. Screw threaded rod 600 is then radially inserted into canine buccal tube 284. Threaded nut 602 and retaining clip 286 can be attached to threaded rod 600 before the rod is inserted in a patient's mouth. Nut 602 is then turned until it touches clip 286 and moves it to touch canine buccal tube 284. Each subsequent turn moves canine tube 284 a defined distance along threaded rod 600 toward molar tube 502, depending on the pitch of the thread. As canine tube 284 moves, attached canine band 262 and canine tooth will also move.

It is evident from the construction of the invention, as shown in the drawings and described in the embodiments, that it is of minimal size and thus protrudes minimally from the dental arch. Because of its small size, this invention is minimally intrusive and is thus a significant improvement over previous inventions, resulting in improved comfort and safety for a patient.

A feature of this invention is that it requires no invasive procedure; that is, the bands are simply placed on teeth and cemented in position.

A feature of this invention is a self-aligning, internally threaded, buccal tube. Because of the small size and pitch of the threaded components, it is difficult to engage them without cross-threading, unless the components are aligned coaxially. The curvature of a dental arch requires the threaded rod to curve as it conforms to the shape of the arch. Thus, it is difficult to coaxially align the internally threaded tube and externally threaded rod or screw when engaging them within the oral cavity. The designs of buccal tube 244, as described and shown in FIGS. 2A-2D, and buccal tube 502, as described and shown in FIGS. 6A-6E, ensures coaxial engagement of the threaded rod or screw within the threaded tube.

The internally threaded buccal tube can have a funnel shaped (tapered) opening to allow the threaded rod to engage easily even when it is not precisely aligned. A portion of the tube, adjacent to the funnel shaped portion, has a smooth bore and is slightly larger diameter than the diameter of the threaded rod or screw so the rod or screw can slide freely within the bore. Adjacent to the smooth bore portion is a threaded portion to engage with the threaded rod or screw. The threaded, smooth, and funnel shaped portions of the tube are aligned coaxially during manufacture.

In preferred embodiments of the invention, the size of the distractor falls within a size envelope. Portions of the device have dimensions that extend from teeth in a buccal direction not to exceed 3 mm for molar tooth. More optimal dimensions are 2 mm or less for the molar tooth, and 3 mm for the canine tooth.

Portions of the device extending in a mesial (anterior or forward) direction do not to exceed 3.5 mm beyond edge of canine tooth. More optimal dimension are 2.5 mm or less for canine tooth.

The device can project in a distal (posterior or rearward) direction not to exceed 5 mm beyond end of the molar tube. A preferred dimension is 2.5 mm to zero mm for molar tube.

The device can project in an occlusal (biting surface) direction not more than half the distance between gum and occlusal surface. A preferred dimension is not more than one quarter the distance between gum and occlusal surface.

The device can project in an apical (root) direction not more than 1 mm below gum line. More optimal dimension is between gum line and 2 mm above gum line.

A critical aspect of this apparatus is that it extends minimally, or not at all, beyond the volume envelope of brackets and tubes that are used during traditional orthodontic treatment. The vast majority of patients tolerate brackets and tubes with little if any discomfort. Since the distractor described herein does not protrude beyond the extent of tubes and brackets usually used for orthodontic treatment, this distractor device is also well tolerated by patients.

A distractor utilizing a single tube has smaller protrusion dimensions than a double tube device, and thus is more advantageous.

A preferred embodiment of an orthodontic distractor can include nesting telescoping tubes which cover or enclose an actuating or coupling element, such as a screw or rod. This embodiment further limits the possibility of discomfort to a patient by ensuring that no components protrude beyond the buccal tubes during orthodontic treatment.

In the case where the nesting telescoping tubes are not round, e.g. square, rectangular, etc., this will control torque and thus help to maintain alignment of teeth.

Increased stiffness of the distractor device described herein can be obtained by using materials having larger elastic moduli than stainless steel, which is the usual material of construction for orthodontic appliances. Tungsten has a significantly larger modulus than stainless steel and is biocompatible. The primary use for a tungsten component is the two piece sequence lingual activating screw.

Selection of a screw thread size for the orthodontic distractor described herein is primarily based on convenience for a patient, and some mechanical considerations. If the thread pitch is too large, it is difficult for the patient to control small movements of the apparatus. If the thread pitch is too small, it is time consuming for the patient to control large movements of the apparatus. A clinically accepted tooth movement rate for canine distalization is about 0.75 mm per day. Thus, a preferred thread pitch is 80 threads per inch, which will produce about 0.63 mm movement per day when activated one turn twice daily. This is convenient for a patient to accomplish, as it requires only 1 complete turn (no fractional turns) and a morning and night adjustment, i.e. twice daily. Also, the protocol can be changed to include fractional turns, such as one third of a turn three times per day.

The screw head can be any geometry, e.g. hex, square, slotted, etc. A hex head is convenient for obtaining a matching socket driver, and is also easy for the patient to engage and adjust. A recessed drive, e.g. Allen, Phillips, etc., allows for a round head with no protrusions to possibly cause irritation, and is also easy for the patient to engage and activate. Economical manufacturing practice indicates that the head design accommodate an activating tool that is readily available in the mass market, such as a standard size socket driver or screwdriver.

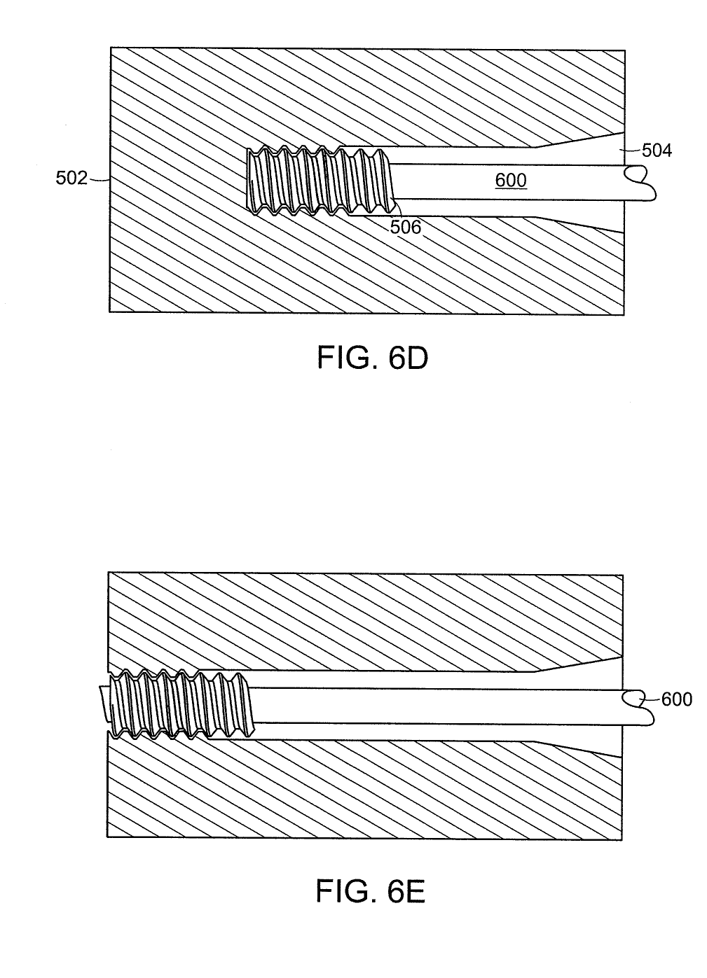

FIGS. 7A-7E show a nested telescoping version of the orthodontic distractor described herein. Tube element 700 is shown as a square tube, although other non-round shapes will accomplish the desired result. Round tubes with splines or slots and complementary engaging pins can also function to produce the desired movement. Tube element 700 is fastened to a molar band on a posterior molar tooth as described previously, typically by spot welding. The spot weld is at or near the unthreaded end of the tube. Outer tube 702 is fastened to a canine band on an anterior canine tooth as described previously, typically by spot welding. The spot weld is at or near the end of the tube that has a clearance hole for a screw 708. FIGS. 7A-7E show a device sized for a #00-90 screw, however, other sizes can also be used. The nested telescoping tubes provide more bending stiffness than the screw and also resist torques that tend to cause misalignment of a tooth as it moves. Thus, in this configuration, a smaller screw size is acceptable and adequate to cause the desired performance of the device. The threading on screw 708 engages threads 720 on the molar tube 700 with length 722 and diameter or width 726 (for round or square shaped tubes, respectively). The threaded portion 720 has a length 724. The lengths 722, 724 can be in a range up to 15 mm. The diameter 748 of the bore within tube 700 is larger than the threaded diameter 750. Tube 702 has size 744 and inner size 746 in which tube 700 can slide.

This invention is a simple device comprised of a minimal number (four or five) of components which are readily manufactured, which results in this invention being an efficient and cost effective device. The components of this invention are comprised of materials which are biologically compatible. They are also of sufficient strength to maintain the forces developed during the orthodontic distraction process, without catastrophic deformation or failure. Persons experienced in the art will understand that materials such as stainless steel and titanium alloys are suitably strong and biocompatible, as well as other materials. The use of other materials of similar performance and properties should not be construed to constitute a new invention.

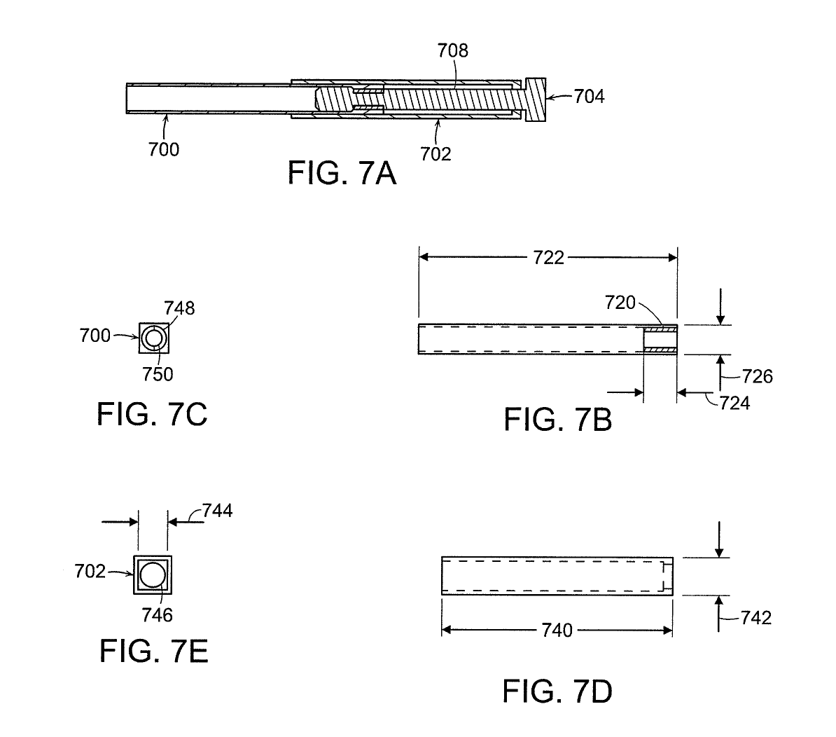

Another benefit of this invention is that the components are prefabricated, and thus are available for immediate chair side use by an orthodontist, without needing dental laboratory work. A preferred method of fabricating a dental distractor in accordance with the invention is illustrated in the process sequence 800 shown in FIG. 8. After threading 802 of an internal bore of a first tube and fabricating a second tube 804 with an optional slot, the tubes are attached 806 to respective tooth bands by welding, for example. The precise position of the weld on each band can be selected based on the needs of the individual patient.

A threaded rod or screw is also fabricated (or obtained commercially) 808, having a thread size that engages the internal bore of the first tube and that slides freely through a bore in the second tube.

For embodiments using a retainer to hold the rod or screw in a slotted second tube, a retainer is fabricated 810 that engages the second tube using a slot that partially extends along the length of the retainer tube.

A preferred embodiment of the invention involves the use of a “balanced” force system when retracting a tooth into a space prepare by extracting a tooth. A method for achieving this result is to use a distractor attached to the buccal side of tooth bands attached to the teeth as described herein. To balance the force exerted by a distractor, a power chain or spring is often used on the lingual side of the teeth. As the distance between two teeth decreases, the extension of a power chain or spring decreases, and thus the force applied to the teeth decreases. While a distractor may be actuated easily on a daily basis by a patient, to maintain force and tooth movement, it is necessary to have an orthodontist replace power chains and springs as they lose force. Thus, a device that applies a “balanced” force, i.e. a comparable force on both the buccal and lingual sides of teeth, and maintains a balanced force as teeth move toward each other, can be desirable. Because this device can be actuated on a daily basis by a patient, to maintain a balanced force system without power chains or springs.

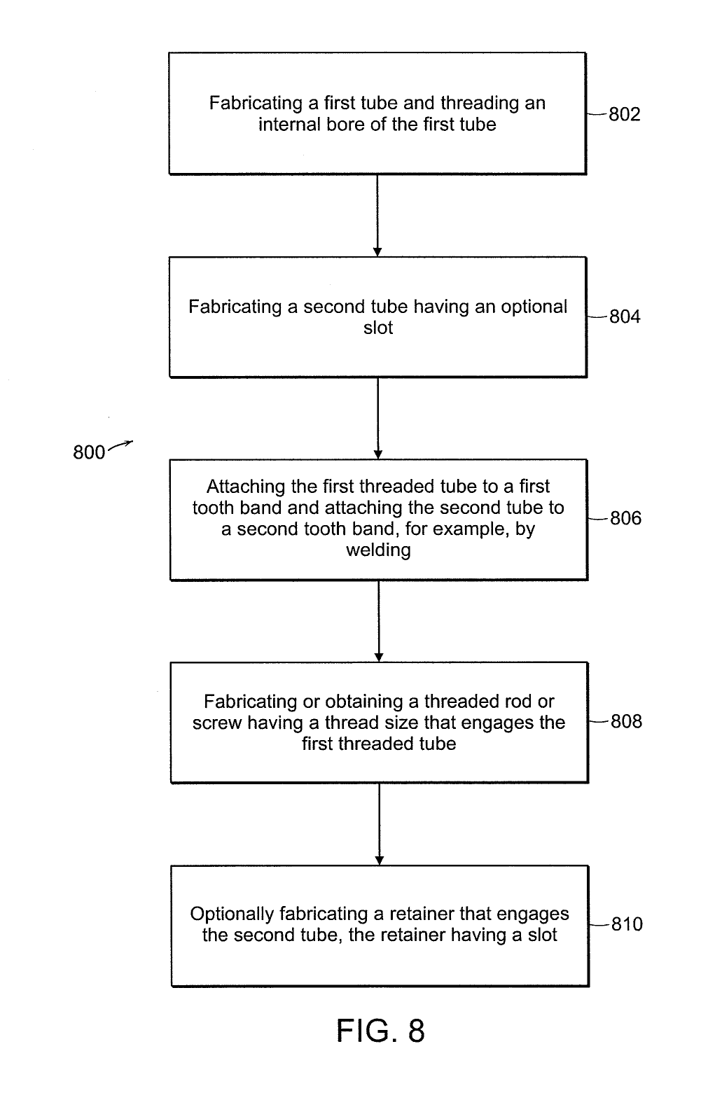

FIG. 9 shows a preferred embodiment of the invention as seen from an occlusal view (in an apical direction). A typical application is represented by a canine tooth 902 being moved toward a molar tooth 904. Molar tooth 906 is an “anchor” tooth that holds the distal (posterior) end of the device essentially stationary in the mouth. A thin metal (or other material) coupling band 908 is used which applies a force against canine band 916. Band 916 is a orthodontic band attached to tooth 902 with an adhesive. Band 918 is a orthodontic band attached to tooth 906, also with an adhesive. The distal (posterior), lingual (inner) end of band 908 is fixedly attached to band 918 at position 920. Tube 910 is fixedly attached to band 908 at position 922, at the distal (posterior), buccal (outer) end of band 908. Tube 912 is fixedly attached to band 918 at position 924. A screw 926 with head 928 is used to maintain the applied force. Tube 910 has an inner dimension slightly larger than the outer dimension of screw 926, so that screw 926 can slide and rotate within the tube. Tube 912 has an internal thread to match screw 926, so that when screw 926 is rotated it will advance into tube 910.

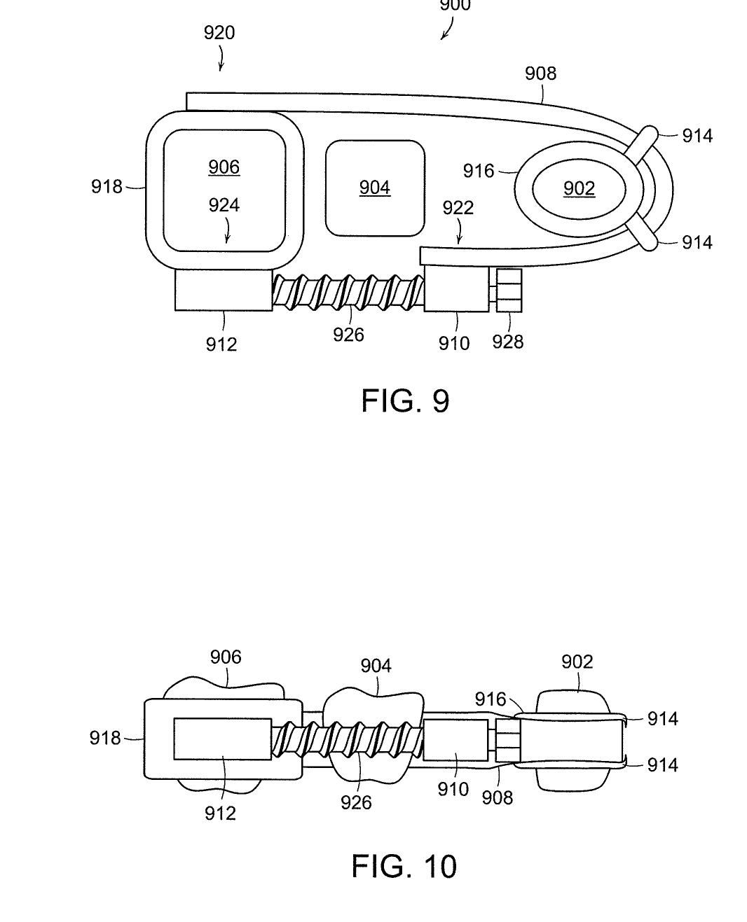

FIG. 10 shows the invention as seen from a buccal view (in a lingual direction). One or more “hooks” or pins 914 prevent band 908 from moving vertically on tooth 902. It will be appreciated that there is enough space within a hook to allow band 908 to move laterally with essentially no rubbing against a hook. The addition of coatings, lubricants, or other surface treatments to reduce friction between band 908 and band 916 can also be utilized.

Rod screw 926 moves tube 910 relative to tube 912. As tube 910 moves toward tube 912, it applies tension to band 908 which causes an almost balanced force (i.e. almost the same value on buccal side as on lingual side) to be exerted on tooth 902. It will be appreciated that as tube 910 move a given distance, tooth 902 will move one half that distance. Thus it is easy to calculate the necessary length of thread on screw 908 for moving tooth 902 a desired distance.

Band 908 has dimensions that are usual for orthodontic treatment. Typically these orthodontic bands are a metal, such as stainless steel, but other materials can also be used.

Tubes 910 and 912 can be attached to bands 908 and 918 respectively by welding, brazing, soldering, or other method such as mechanical fastening. Additional tubes can also be added as described previously to provide the option of using additional wires to adjust movement.

The disclosed invention and its preferred embodiments, as well as modifications thereof, are defined by the accompanying claims and descriptions. Thus, the appended claims are intended to cover all embodiments which do not depart from the spirit and scope of the invention.

What is claimed is:

1. A dental distractor for rapid orthodontic tooth movement, comprising:
a first tooth band having a first tube body mounted on a side surface of the first tooth band, the first tube extending 4 mm or less from the first tooth band side surface, the first tooth band being adapted to mount on a first tooth;
a second tooth band and a second tube body mounted relative to a side surface of the second tooth band, the second tube body having a size 4 mm or less, the second tooth band being adapted to mount on a second tooth; and
a coupling element that couples the first tube body and the second tube body such that actuation of the coupling element applies a force between the first tooth band and the second tooth band.

2. The device of claim 1 wherein the second tube body is mounted to the side surface of the second tooth band.

3. The device of claim 1 wherein the second tube body is attached to a band such that a force is exerted on a buccal side and a lingual side of the second tooth.

4. The device of claim 3 wherein a first portion of the band is attached to the second tube body and a section portion of the band is attached to a second side surface of the first tooth band.

5. The device of claim 1 wherein the first tooth band is adapted to be mounted on a molar tooth and the second tooth band is adapted to be mounted on a canine tooth band.

6. The device of claim 5 wherein the second tube body comprises a canine tube mounted on the canine tooth band.

7. The device of claim 6 wherein the canine tube has an axial slot to allow the coupling to be inserted into the canine tube through the slot.

8. The device of claim 7 wherein the first tube body comprises a molar tube counterbored at the anterior (mesial) end to provide clearance for the coupling, and threaded at a posterior (distal) portion to engage threads on the coupling.

9. The device of claim 7 wherein a retaining clip, engages the canine tube to prevent the coupling from disengaging from the canine tube.

10. The device of claim 1, wherein the coupling element comprises a screw having a screw head.

11. The device of claim 6 wherein the molar tube and canine tube are 3 mm or less in diameter.

12. The device of claim 6 wherein the canine tube is mounted on a buccal side of the canine band and the molar tube is mounted on a buccal side of the molar band.

13. The device of claim 6 wherein the canine tube has a smooth bore.

14. The device of claim 6 wherein the canine tube is welded, brazed or soldered to the canine band.

15. The device of claim 6 wherein the canine tube contacts the molar tube.

16. The device of claim 6 wherein the canine tube slides within the molar tube.

17. The device of claim 6 wherein the molar tube slides within the canine tube.

18. The device of claim 6 further comprising a second molar tube attached to the molar band and a second canine tube attached to the canine band.

19. The device of claim 1 wherein the coupling element applies a force between the first tube body and the second tube body.

20. The device of claim 1 wherein the coupling element comprises:
a rod attached to the molar tube and passing through the canine tube;
a threaded nut on a threaded portion of the rod, at the anterior (mesial) end of the canine tube, such that turning the nut moves the canine band toward the molar band.

21. A method of fabricating a dental distractor comprising:
attaching a first tube body having a size of 4.0 mm or less to a first tooth band;
attaching a second tube body having a size of 4.0 mm or less to a band; and
forming a second coupling element that attaches to the first tube body and the second tube body, the coupling element having an actuator that applies a force between the first tube body and the second tube body.

22. The method of claim 21 further comprising attaching the first tube body including a molar tube to a molar band.

23. The method of claim 22 further comprising attaching the second tube body including a canine tube to a canine tooth band.

24. The method of claim 21 further comprising forming the first tube body with one or more attachment elements.

25. The method of claim 21 further comprising forming the second tube body with one or more attachment elements.

26. The method of claim 22 wherein the step of attaching the molar tube to the molar band is a process selected from the group comprising welding, soldering or brazing the tube to the band.

27. A method of using a dental distractor for rapid tooth movement comprising:
attaching a molar band having a molar tube to a molar tooth of a patient;
attaching a canine band coupled to a canine tube to a canine tooth of the patient;
attaching a threaded coupling to the molar tube and the canine tube; and actuating the coupling to apply a force to move the canine tooth towards the molar tooth.

28. The method of claim 42 wherein the step of attaching a molar band to the molar tooth comprises positioning the molar tube to extend in a normal direction 3 mm or less from a buccal surface of the molar tooth.
